(19) United States
(12) Patent Application Publication
(10) Pub. No.: US 2025/0018698 A1
(43) Pub. Date: Jan. 16, 2025

(54) MULTIPLE COMPOSITE-LAYER CHOPPING BOARD MADE OF HETEROGENEOUS MATERIALS

(71) Applicant: Jung-Hsien Hsieh, Tainan City (TW)

(72) Inventor: Jung-Hsien Hsieh, Tainan City (TW)

(21) Appl. No.: 18/898,334

(22) Filed: Sep. 26, 2024

Related U.S. Application Data
(62) Division of application No. 17/994,511, filed on Nov. 28, 2022.

(51) Int. Cl. B32B 27/08

(52) U.S. Cl. CPC B32B 27/08; B32B 2272/00; B32B 2307/581; B32B 2307/7145

(57) ABSTRACT

A multiple composite-layer chopping board made from heterogeneous materials is configured to extrude a successive substrate in a width by using an extruder. The successive substrate is punched to form multiple rectangle plates in a desired size by way of a punching mold. The multiple rectangle plates are moved into a milling machine to be machined four corners of each of the multiple rectangle plates and to trim a groove of a first top face, thus producing the multiple composite-layer chopping board.

### FIELD OF THE INVENTION

The present invention related to a multiple composite-layer chopping board made of heterogeneous materials and method of making the same, and more particularly to the multiple composite-layer chopping board made by the extruder from multiple-layer materials to produce the multiple composite-layer chopping board in a desired width and a stable quality.

### BACKGROUND OF THE INVENTION

A conventional multiple composite-layer chopping board (with at least two-layer structure) is injection molded from plastic materials of different colors or properties by using a double injection molding machine. However, the double injection molding machine includes two molds. When designing the double injection molding machine, it has to consider whether the two molds will interface when the two molds rotate. The two molds of the double injection molding machine rotate to form a multiple-layer structure, thus causing a slow production speed, a crack, a high cost and price to the conventional multiple composite-layer chopping board.

When rejection molding the conventional multiple composite-layer chopping board from different plastic materials, the polymerizations of the plastic materials in a high-temperature melting conditions are different to shrink and pull the plastic materials, so the multiple composite-layer chopping board is curved and has a non-tight structure to reduce its quality.

The multiple composite-layer chopping board is impacted by a knife for chopping ingredients, so it is essential to reinforce the multiple composite-layer chopping board by increasing a thickness of the multiple composite-layer chopping board, thus making the multiple composite-layer chopping board from homogeneous raw plastic granules in different colors in a high cost.

The multiple composite-layer chopping board contains a connection face connected on a middle portion thereof, and the multiple composite-layer chopping board contains a substrate formed on a bottom thereof, wherein the connection face and the substrate are made of homogeneous raw plastic granules, thus increasing carbon footprint to be against environmental protection.

The present invention has arisen to mitigate and/or obviate the afore-described disadvantages.

### SUMMARY OF THE INVENTION

The primary aspect of the present invention is to provide a method of making a multiple composite-layer chopping board made of heterogeneous materials which is extruded successively to a successive substrate in a desired width and a stable quality.

Secondary aspect of the present invention is to provide a multiple composite-layer chopping board made of heterogeneous materials and a method of making the same which contain a first top face and a second top face made of raw plastic granules with bacteria and impact resistances, wherein a connection face is made of recycled plastic granules, thus reducing plastic consumption to protect environment.

Third aspect of the present invention is to provide a multiple composite-layer chopping board made of heterogeneous materials and a method of making the same by which the successive substrate is punched by the punching mold to produce the multiple rectangle plates, and the multiple rectangle plates are moved into the milling machine to machine a profile of each rectangle plate and the groove, thus obtaining quick production, a low machining and mold cost, and a high product yield.

Another aspect of the present invention is to provide a multiple composite-layer chopping board made of heterogeneous materials and a method of making the same by which a size and a profile of the multiple rectangle plates are adjustable and changeable based on using requirements by way of the milling machine to decrease a material inventory and to change the size and the profile of the multiple rectangle plates.

A method of making a multiple composite-layer chopping board from heterogeneous materials is configured to extrude a successive substrate in a width by using an extruder. The successive substrate is punched to form multiple rectangle plates in a desired size by way of a punching mold, and the multiple rectangle plates are moved into a milling machine to be machined four corners of each of the multiple rectangle plates and to trim a groove of a first top face, thus producing the multiple composite-layer chopping board.

The multiple composite-layer chopping board made by the method contains: a top face and at least one connection face.

The top face is connected on a top of the multiple composite-layer chopping board and made of raw plastic granules with bacteria and impact resistances. The at least one connection face is defined between a top and a bottom of the multiple composite-layer chopping board or on a bottom of the multiple composite-layer chopping board, and the at least one connection face is made of recycled plastic granules.

The multiple composite-layer chopping board made by the method contains: a top face and at least one connection face, wherein the top face has a groove defend thereon, a profile of the groove of the first top face corresponds to a profile of the multiple composite-layer chopping board, and a cross section of the groove is semicircular.

A depth of the groove is more than a thickness of the first top face so as to expose the connection face. When colors of the first top face, the second top face and the connection face are different, the groove has different color effects.

A variety of pigments having different colors are added to the first top face, the second top face and the connection face to produce the multiple composite-layer chopping boards of different colors, thus distinguishing multiple composite-layer chopping boards for chopping cooked ingredients and raw ingredients respectively.

A profile of the multiple composite-layer chopping board is rectangle, and four corners of the multiple composite-layer chopping board are machined by using a milling machine to be arcuate.

Accordingly, the multiple composite-layer chopping board and the method of making the same have advantages as follows:

1. When making the multiple composite-layer chopping board, the extruder extrudes the successive substrate with multiple layers and the width quickly.

2. The first top face and the second top face are made of the raw plastic granules, and the connection face is made of the recycled plastic granules, thus reducing the plastic consumption and to protect the environment.

3. The successive substrate is punched by the punching mold to produce the multiple rectangle plates, and the multiple rectangle plates are moved into the milling machine to machine a profile of each rectangle plate and the groove, thus obtaining quick production, a low machining and mold cost, and a high product yield.

4. A size and a profile of the multiple rectangle plates are adjustable and changeable based on using requirements by way of the milling machine to decrease a material inventory and to change the size and the profile of the multiple rectangle plates.

### BRIEF DESCRIPTION OF THE DRAWINGS

FIG. 1 is a flow chart of making a multiple composite-layer chopping board according to a preferred embodiment of the present invention.

FIG. 2 is a schematic view showing a successive substrate of the multiple composite-layer chopping board being produced according to the preferred embodiment of the present invention.

FIG. 3 is a perspective view showing multiple rectangle plates being produced according to the preferred embodiment of the present invention.

FIG. 4 is a perspective view showing multiple rectangle plates being machined according to the preferred embodiment of the present invention.

FIG. 5 is a perspective view showing the assembly of the multiple composite-layer chopping board according to the preferred embodiment of the present invention.

FIG. 6 is a schematic view showing a successive substrate of the multiple composite-layer chopping board being produced according to another preferred embodiment of the present invention.

FIG. 7 is a perspective view showing the assembly of the multiple composite-layer chopping board according to another preferred embodiment of the present invention.

### DETAILED DESCRIPTION OF THE PREFERRED EMBODIMENTS

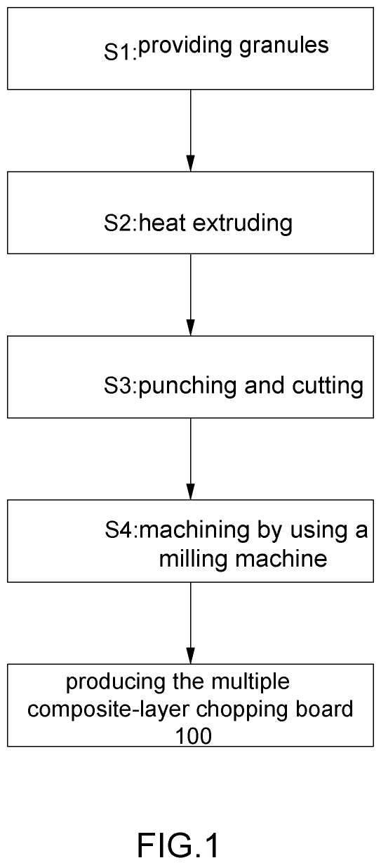

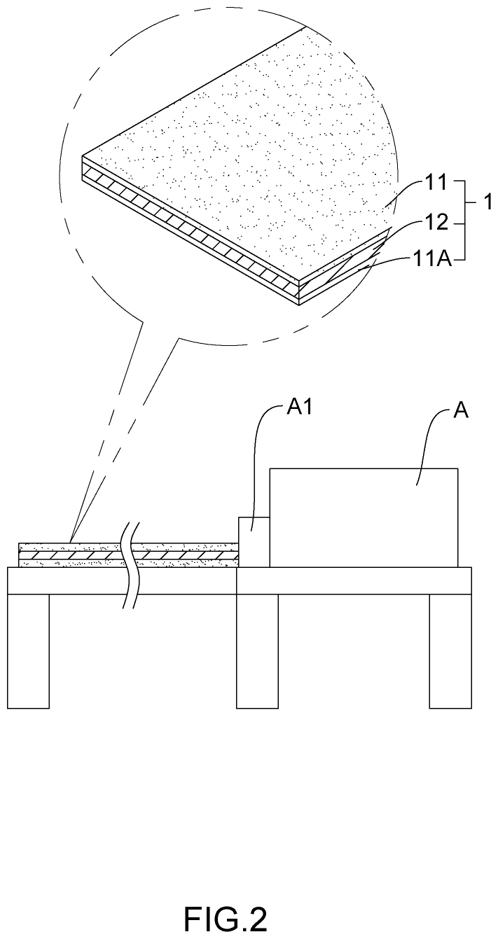

With reference to FIGS. 1-5, a method of making a multiple composite-layer chopping board comprises steps of:
providing granules S1, wherein accommodating raw plastic granules with bacteria and impact resistances and accommodating recycled plastic granules in a storage tank;
heat extruding S2 as shown in FIGS. 1 and 2, wherein the raw plastic granules and the recycled plastic granules are heated and melted, then the raw plastic granules and the recycled plastic granules are extruded by an extruder A and are cut in a predetermined length to produce a successive substrate 1 in a desired width; wherein the extruder A includes an extrusion head A1 configured to extrude the successive substrate 1; wherein after the extrusion head A1 is extruded, the successive substrate 1 is cooled by soaking the successive substrate 1 in a coolant or by blowing cold airs to the successive substrate 1; wherein the successive substrate 1 includes a first top face 11, a connection face 12, and a second top face 11A connected on a bottom of the connection face 12, wherein the first top face 11 and the second top face 11A are made of the raw plastic granules, and the connection face 12 is made of the recycled plastic granules, such that the successive substrate 1 includes the first top face 11 and the second top face 11A on which ingredients are chopped. In another embodiment, the extrusion head A1 is configured to produce a double composite-layer chopping board, for example, the connection face 12 is only connected with a top face 11.

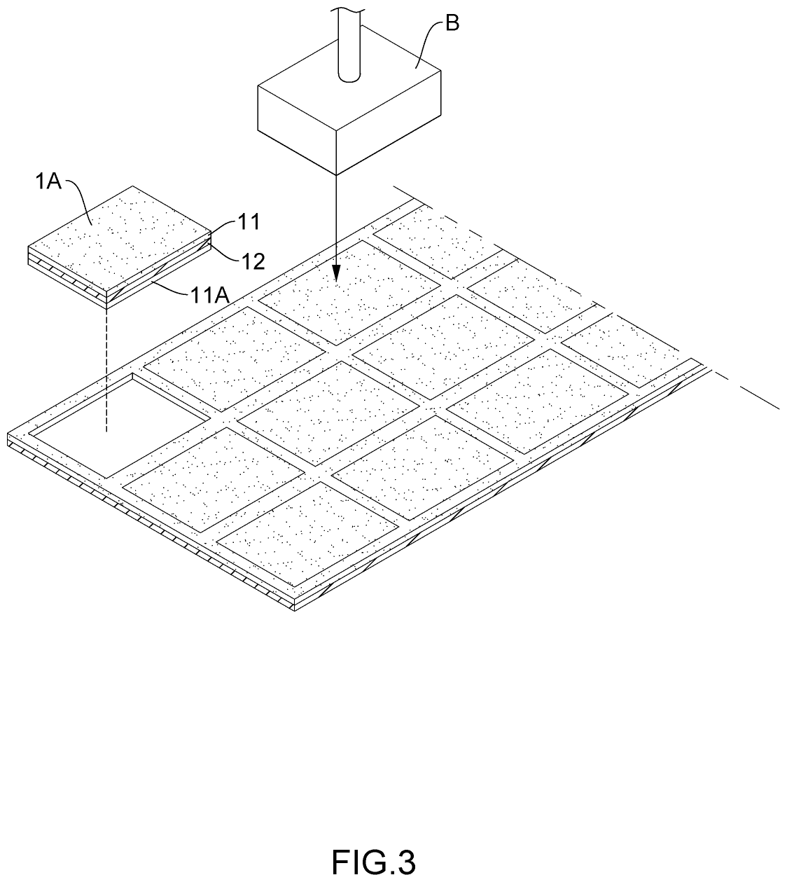

Referring to FIGS. 1 and 3, the method of the present invention further comprises a step of: punching and cutting S3, wherein a punching mold B is configured to punch the successive substrate 1, thus producing multiple rectangle plates 1A in a desired size, as shown in FIG. 3, after the multiple rectangle plates 1A are removed, scrapped plastics are crushed by using a crusher to produce the recycled plastic granules applicable for the step of providing granules S1, thus reducing plastic consumption to protect environment.

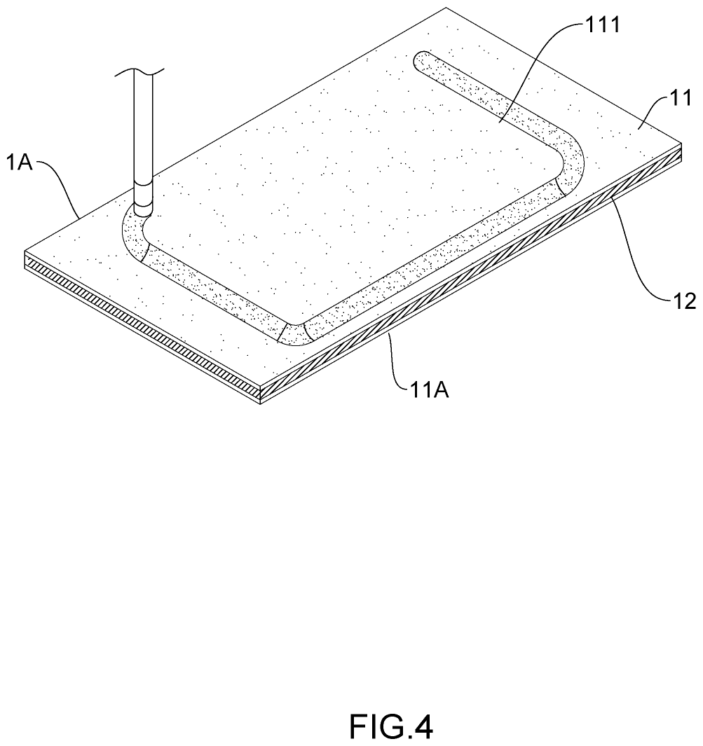

As illustrated in FIGS. 1 and 4, the method of the present invention further comprises a step of machining by using a milling machine, wherein the multiple rectangle plates 1A are moved into the milling machine to be machined four corners of each of the multiple rectangle plates 1A and to trim a groove 111 of the first top face 11, wherein a depth of the groove 111 is more than a thickness of the first top face 11, and a profile of the four corners of each rectangle plate 1A is arcuate, thus producing the multiple composite-layer chopping board 100. Also, the second top face 11A has a groove (not shown) defined thereon.

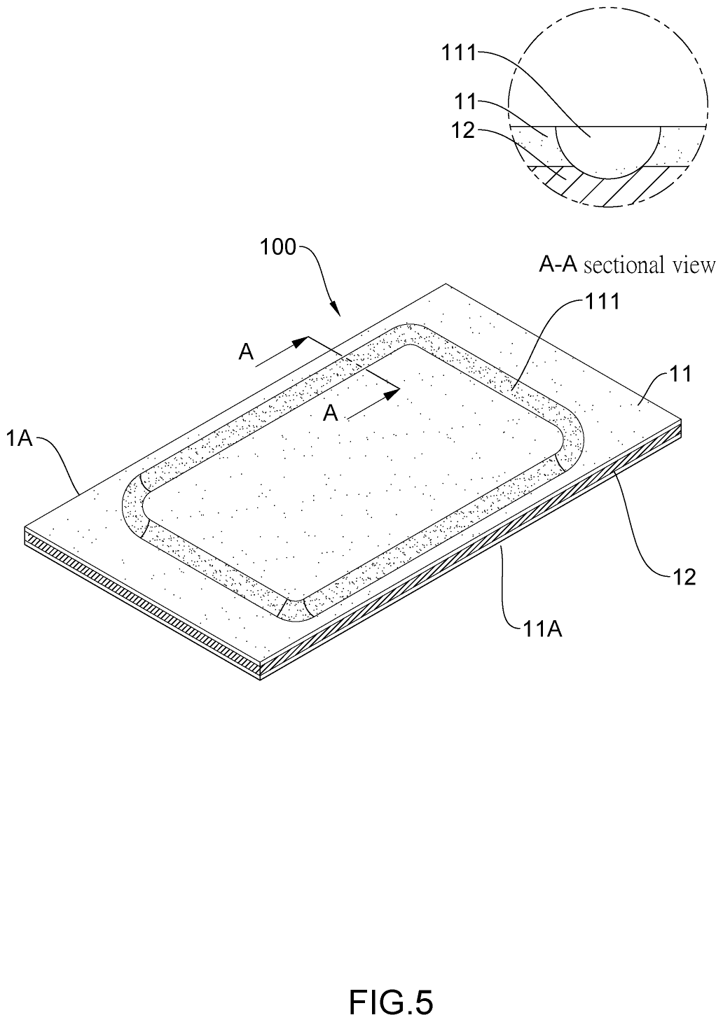

With reference to FIG. 5, the multiple composite-layer chopping board 100 comprises a first top face 11, a connection face 12, and a second top face 11A, wherein the first top face 11 has a groove 111 defined thereon, and a profile of the groove 111 of the first top face 11 corresponds to a profile of the multiple composite-layer chopping board 100, a cross section of the groove 111 is semicircular so that the groove 111 accommodates fluids producing from chopping the ingredients, such as vegetables and meats, thus avoiding a leakage of the fluids and maintaining clean to the multiple composite-layer chopping board 100.

The first top face 11 and the second top face 11A are made of the raw plastic granules, and the connection face 12 is made of the recycled plastic granules, thus reducing the plastic consumption and to protect environment.

Accordingly, the multiple composite-layer chopping board and the method of making the same have advantages as follows:

1. When making the multiple composite-layer chopping board 100, the extruder A extrudes the successive substrate 1 with multiple layers and the width quickly.

2. The first top face 11 and the second top face 11A are made of the raw plastic granules, and the connection face 12 is made of the recycled plastic granules, thus reducing the plastic consumption and to protect the environment.

3. The successive substrate 1 is punched by the punching mold B to produce the multiple rectangle plates 1A, and the multiple rectangle plates 1A are moved into the milling machine to machine a profile of each rectangle plate 1A and the groove 111, thus obtaining quick production, a low machining and mold cost, and a high product yield.

4. A size and a profile of the multiple rectangle plates 1A are adjustable and changeable based on using requirements by way of the milling machine to decrease a material inventory and to change the size and the profile of the multiple rectangle plates 1A.

5. A variety of pigments having different colors are added to the first top face 11, the second top face 11A and the connection face 12 to produce the multiple composite-layer chopping boards 100 of different colors, thus distinguishing multiple composite-layer chopping boards 100 for chopping cooked ingredients and raw ingredients respectively.

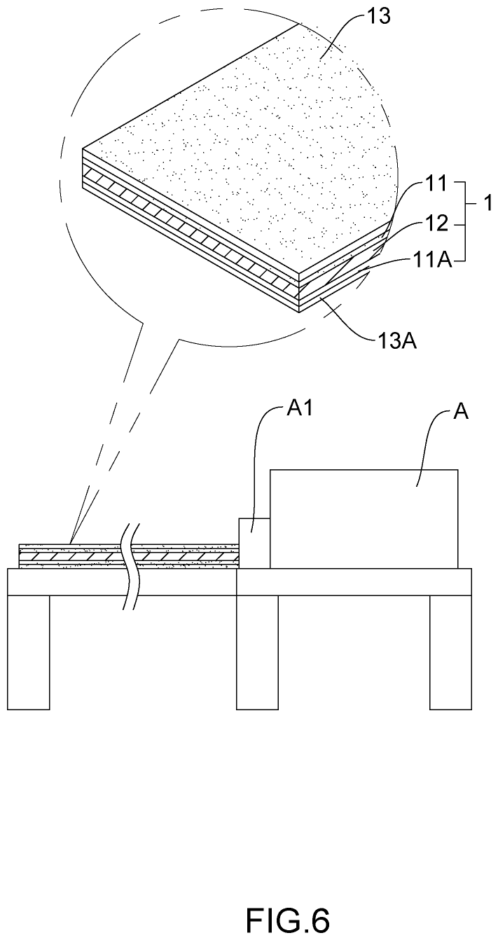

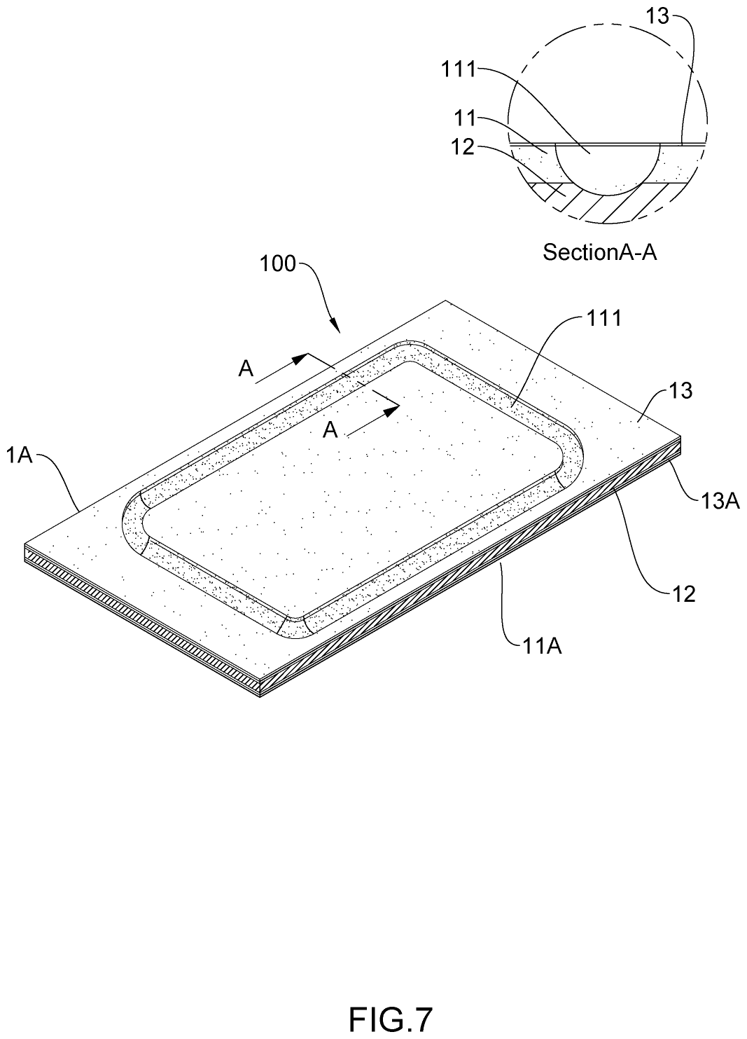

6. The multiple composite-layer chopping board 100 is impact resistant and is anti-slip. For example, as illustrated in FIGS. 6 and 7, the successive substrate 1 includes a first protection layer 13 formed on the first top face 11, and the successive substrate 1 includes a second protection layer 13A formed on the second top face 11A, thus producing the multiple composite-layer chopping board 100 having the first top face, the second top face, the connection face, the first protection layer, and the second protection layer. Preferably, the first and second protection layers 13, 13A facilitate impact and slip resistances.

While the preferred embodiments of the invention have been set forth for purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A multiple composite-layer chopping board made from heterogeneous materials, comprising: at least one top face and a connection face;
wherein the at least one top face is formed on a top or a bottom of the multiple composite-layer chopping board and made of raw plastic granules with bacteria and impact resistances; and the connection face is defined between the top and the bottom of the multiple composite-layer chopping board or on the bottom of the multiple composite-layer chopping board, wherein the connection face is made of recycled plastic granules.

2. The multiple composite-layer chopping board as claimed in claim 1, wherein the at least one top face has a groove defend thereon, a profile of the groove corresponds to a profile of the multiple composite-layer chopping board, and a cross section of the groove is semicircular.

3. The multiple composite-layer chopping board as claimed in claim 1, wherein a profile of the multiple composite-layer chopping board is rectangle, and four corners of the multiple composite-layer chopping board are machined by using a milling machine to be arcuate.

4. The multiple composite-layer chopping board as claimed in claim 1, wherein a depth of the groove is more than a thickness of the at least one top face.

5. The multiple composite-layer chopping board as claimed in claim 1, further comprising a protection layer formed on the at least one top face.
